(19) United States
(12) Patent Application Publication
(10) Pub. No.: US 2016/0048785 A1
(43) Pub. Date: Feb. 18, 2016

(54) A COMPUTER IMPLEMENTED SYSTEM AND METHOD FOR PROJECT CONTROLS

(71) Applicant: Nagaraju DOMMARAJUKRISHNAMARAJU, (US)

(72) Inventor: Nagaraju Dommarajukrishnamaraju, Hyderabad (IN)

(21) Appl. No.: 14/783,597

(22) PCT Filed: Apr. 15, 2014
(86) PCT No.: PCT/IB2014/060721

§ 371 Date: Oct. 9, 2015

(30) Foreign Application Priority Data
Apr. 11, 2013 (IN) 1651/CHE/2013

(51) Int. Cl. G06Q 10/06

(52) U.S. Cl. CPC G06Q 10/06313; G06Q 10/067

(57) ABSTRACT

A computer implemented project control system and method adapted for enabling an efficient management of a project. The present invention bridges the gap that has traditionally existed between planning and managing project execution and is to provide an efficient, improved, computer implemented project management system with effective monitoring and controlling method which allows a better management of a project schedule, resources and cost. The invention further develops an application comprising a server based and web enabled data base supported by user friendly front end application for managing the projects in a multi user environment. The present invention allows concurrent usage on multi project environment by providing a reliable, secured and practical project management system. The present invention has capabilities for real time project data collaboration, manipulation and performance monitoring system. The invention make ease of using built in tools to produce standard periodical reports or customized reports with a facility to create the layout using data base record of items and using drilldown, filtering, grouping, sorting and summarisation options.

### TECHNICAL FIELD OF THE INVENTION

The present invention generally relates to a project control system and method. More particularly, the present invention is related to a computer implemented project control system and method adapted for enabling an efficient management of a project or group of projects in multi tired organization structure.

### BACKGROUND OF THE INVENTION

With the advent of the computer age, computer and software users have grown accustomed to user-friendly software applications that help them write, calculate, organize, prepare presentations, send and receive electronic mails, make music, and the like. Modern word processing applications, allow users to create and edit a variety of useful documents. Modern project management applications, for another example, allow users to create project management schedules for organizing and managing tasks, resources and labor associated with a variety of projects.

Manual and computerized project control systems allow managers and planners to organize and plan the tasks, resources and schedules required for completion of a given project. In most projects, a number of dependencies and constraints dictate the timing and completion of an overall project and of sub-projects comprising the overall project. For example, in a house construction project, a drywall sub-project may not typically begin until the completion of electrical work. And, a number of sub-projects may be constrained by the availability of labour and resources.

A typical project control system includes a scheduling engine that is responsible for calculating the start dates and finish dates of the project milestones and individual project tasks comprising project milestones based on user provided data including task start dates, resources, constraints and dependencies. The scheduling engine is typically responsible for maintaining the relationships between milestones and tasks of a given project based on such project information. For example, if a given project contains three milestones or project phases and a dependency provided to the scheduling engine requires that a second milestone may not begin until a first milestone is completed, the scheduling engine will maintain this relationship even if the entire project management schedule must be periodically recalculated. For example, if completion of a task contained in the first milestone slips by two weeks causing completion of the first milestone to slip by two weeks, the scheduling engine will automatically push the start date of the second milestone out two weeks in order to maintain the dependency of the second milestone on the first milestone.

Unfortunately, such automatic recalculation and reconstruction of the project management schedule may reduce the value of the schedule to project managers because the schedule becomes a mere snapshot of the presently calculated and displayed project schedule without regard to the management of individual sub-projects of a given project by managers of those portions of the project. Such maintenance of the project management schedule by the project or sub-project manager becomes time consuming and cumbersome.

Managing the Project time through activity schedule is one of the Project Management primary constraint and managing the day to day cost, Scope of work are the two other primary constraints of the project management. Monitoring of the performance of the resources is the one another common constraints. Time, cost and scope of any project affect the performance. If we want to increase or decrease scope, time or cost, one of the others has to change as well.

Unfortunately, there is no single effective project control system available. Even larger projects are being managed by storing and recording the essential day to day project information either in hard copies or soft copies like MS excel sheets etc., or other form of decentralized databases or applications. By adopting non-standard practice and decentralized method of storing information will result in loosing of essential project data by ignorance of the project team.

Adopting non-standard practices in collecting data results in minimized transparency and visibility of project status and its performance at any given point of time for the project management team. In most cases collecting reliable data, finding the answers is daunting and difficult. Most of the Organizations have lacked the proper tools. Finance and ERP systems have proven cumbersome and too rigid for project planning and cost controls since they focus on accounting needs. Scheduling systems lack the necessary focus on costs and historical data. Even organizations delivering large megaprojects still rely heavily on Excel spreadsheets and manual, disconnected processes for forecasting, managing as-built historical records and performance measurement. These manual processes for data collaboration, manipulation and reporting system are time consuming, error-prone, and leave little time for analysis and making performance improving recommendations and taking corrective timely actions.

By adopting the non-standard practice and decentralized method of storing information results in loosing of essential project data by ignorance of the project team in the absence of common standard practice for all the project team. Difficulty increases in collecting data and its compilation from project team at regular intervals and requirement of additional resources and efforts there on. Real time data collaboration and monitoring system electronically, lack of transparency and visibility of project status and its performance at any given point of time for the project management team, lost opportunity in terms of right timing to take corrective actions by the project managers, lack of as built records along with actual resources productivity records and project performance information on the project for future business development.

In light of the aforementioned present available systems and methods, there clearly exists a need for an alternative system that can bridge the gap that has traditionally existed between planning and managing project execution. There exists a need for an alternative, integrated and more effective improved computer implemented project control system with real time data collaboration and effective monitoring and controlling method which allows better management of a project schedule, resources and cost.

### BRIEF SUMMARY OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In accordance with teachings of the present disclosure, a computer implemented project control system and an effective project management method is disclosed.

A principal objective of the present invention is to provide an efficient, improved, computer implemented project control system with effective project management method which allows a better management of a project schedule, resources and cost.

Another objective of the present invention is to develop an application consisting a server based and web enabled data base supported by user friendly front end application for managing the projects in a multi user environment.

Further objective of the present invention is to provide a reliable, secured and practical project control system and method to manage in multi user environment.

Yet another objective of the present invention is to provide a computer implemented system for managing multiple projects of a similar type which would allow common reference data, documentation, best practices, etc., to be used across all projects.

Still another object of the present invention is to provide the computer implemented system which allows a user to store, modify or edit, search, retrieve, create or generate, track, support, manage and maintain the data from and to an application which enables the efficient management of day to day activities of a project.

Another objective of the present invention is to provide a concurrent usage on multi project environment under enterprise project structure.

Yet another objective of the present invention is to provide fully developed and single system to implement across the organization with complete inbuilt solutions.

Further objective of the present invention is to provide an economical user friendly application which does not require formal training to make use of.

Still further objective of the present invention is to develop an application which has capacity to store and manage large volumes of data and provides back up facility to compress and archive data when not required.

Still another objective of the present invention is to make ease of using built in tools to produce various reports out of large volume of records using user friendly and visible options for filters, grouping, sorting and summarisation.

Yet another objective of the present invention is to eliminate a traditionally existing gap between planning and management of a project execution.

Still further objective of the present invention is to perform best practice project cost controls directly within a single system instead of relying on multiple systems and disconnected practices.

Yet further objective of the present invention is to provide an easy to use, flexible and practical approach in implementation of business rules for project control system across an entire organization.

According to an exemplary embodiment of the present invention, a computer implemented project control system and method adapted for enabling an efficient management of a project is disclosed. The computer implemented project control system for enabling an efficient management of a project includes an application for performing the efficient management of the project. The application for performing the efficient management of the project further includes multiple modules including a server based and web enabled database for storing the data related to the project together with data defining interdependencies of the objects.

In accordance with a non-limiting exemplary embodiment of the present invention, the application for performing the efficient management of the project includes a control system connected to the multiple modules and provides access to the multiple modules as well as for controlling the operation of the multiple modules present in the application.

According to an exemplary embodiment of the present invention, the application for performing the efficient management of the project includes the server based and web enabled data base supported by user friendly front end application for managing the projects in a multi user environment, with a particular emphasis for managing day to day resources and cost of the projects in Engineering, construction and manufacturing industry environment for a multiple of private companies and government organisations.

In accordance with the subject of the present invention, the application for performing the efficient management of the project includes an organizational break down structure for facilitation remote management of the project through web enabled network source. The computer implemented management system includes multiple remotely located entities utilizing the application and facilitates the remote management of the multiple remotely located entities projects.

According to a non-limiting exemplary embodiment of the present invention, the application for performing the efficient management of the project includes a remotely located application server for coordinating the operation of the control system further facilitating the management of the projects of the remotely located entities.

In accordance with an exemplary embodiment of the present invention, the work breakdown structure defines the project tasks. The work breakdown structure is organized as set of hierarchical related project tasks.

According an object of the present invention, the computer implemented method adapted for enabling an efficient management of a project is disclosed. The computer implemented method adapted for enabling an efficient management of a project includes retrieving task related work schedule from the database, each task related work schedule being configurable to describe an activity to be performed by available resources; identifying a set of resources for performing the task, the set of resources being retrieved from the database and describing personnel, equipment, parts and tools, each personnel entry in the resource structure identifying a skill number; allocating the set of resources to perform the task objects; optimizing the resource allocation to the task objects; and displaying an optimized resource allocation using the user interface for assignment of task objects to available resources.

According to a first aspect of the present invention, the computer implemented project control system adapted for enabling an effective management of a project including an enterprise project structure module configured to generate a computerized simulation model representing a plurality of project details, at least one secured central database for storing the details of the plurality of projects by enabling a multiuser environment, at least one user management module for adding at least one of a user, a user profile and a user privilege, a plurality of libraries comprising at least one central library, at least one project library for maintaining a reference data, a plurality of built in tools built in tools to produce a plurality of standard periodical reports, at least one central processing module for performing a plurality of project related operations and at least one remotely located central server for facilitating a communication between the enterprise project structure module and the at least one secured central database for enabling an operation.

According to a second aspect of a present invention, the effective method of managing a project execution, the method comprising a step of adding at least one of a user; a user profile; and a user privilege by utilizing at least one user management module, a step of retrieving a plurality of project tasks from at least one secured central database, wherein the project task determines an activity to be performed by available resources, a step of displaying the plurality of project tasks to a user for enabling an efficient organization of available resources, a step of scheduling the plurality of resources for enabling a completion of the plurality of project tasks at a predetermined time, a step of tracking a completion status of the plurality of projects and a step of updating a status of the plurality of tasks of the plurality of projects in the at least one secured central database.

### BRIEF DESCRIPTION OF THE DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 is a diagram depicting a relationship between a multiple primary constraints and a common constraint.

FIG. 2 is a flowchart depicting a process flow of a computer implemented project control system and method in accordance with an exemplary embodiment of the present invention.

FIG. 3 is a flow chart depicting a concentric flow of a data for project and respective report generation in accordance with an exemplary aspect of the present invention.

FIG. 4 is a diagram depicting a life cycle of a computer implemented project control system in accordance with an exemplary embodiment of the present invention.

FIG. 5 is a diagram depicting a life cycle of a computer implemented project control system module for setting project rules, budgets and baselines in accordance with an exemplary embodiment of the present invention.

FIG. 6 is a diagram depicting a life cycle of a computer implemented project control system module for resources procurement and their management in accordance with an exemplary embodiment of the present invention.

FIG. 7 is a diagram depicting a life cycle of a computer implemented project control system module for creation and management of current and historical as-built records in accordance with an exemplary embodiment of the present invention.

FIG. 8 is a diagram depicting a life cycle of a computer implemented project control system module for reports generation and performance monitoring in accordance with an exemplary embodiment of the present invention.

FIG. 9 is a diagram depicting a RPC system module for EPS and project list along with project attributes in accordance with an exemplary embodiment of the present invention.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

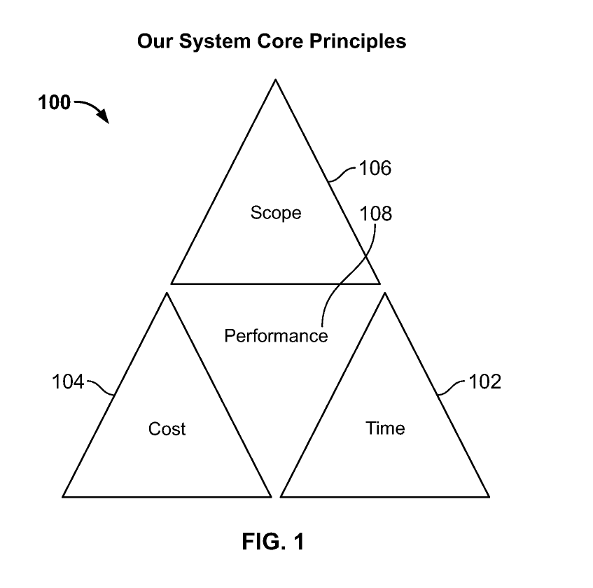

Referring to FIG. 1 is a diagram 100 depicting a relationship between a multiple primary constraints and a common constraint. The triangle depicts the relationship between the multiple primary constraints time 102, cost 104, scope 106 and the common constraint performance 108. If any of the three primary constraints changes, others changes too. For example, if scope 106 is included, time 102 or cost 104 goes up as well. If the delivery need to take place in less time 102, either budget need to be increased or you scope 106 need to be reduced. If a less expensive product is selected, either the scope 106 is reduced or the time 102 taken to complete the project is reduced. If change occurs in any one of the primary constraints, the performance 108 factor will also change.

As there is a strong inter relationship exists between these four constraints, it is very essential to have a standard mechanism and single effective project control system in place for the project managers to monitor these constraints at regular intervals and take timely corrective actions to manage the project to meet project goals and objectives. Managing the project time through activity schedule is one part of the project management primary constraint and managing the day to day cost including but not limited to resources, material and equipment's, scope including but not limited to quantity of work are the two primary constraints of the project management and monitoring of their performance such as quality is the other common constraint.

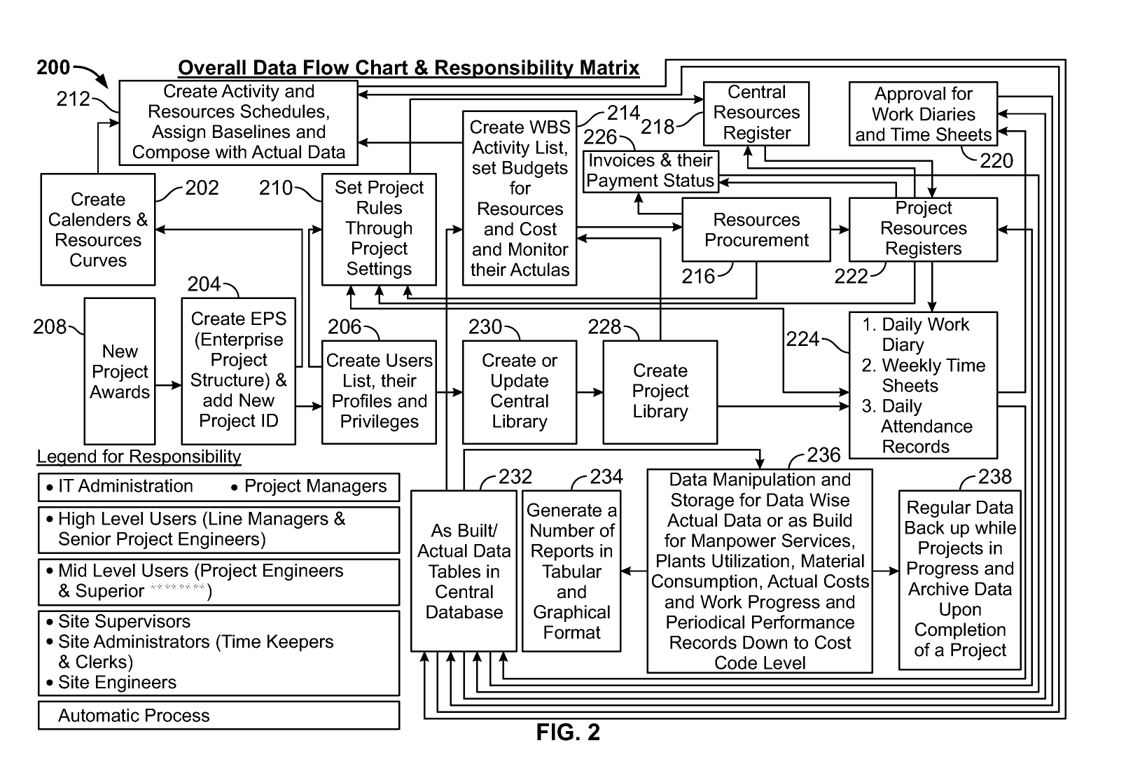

Referring to FIG. 2 is a flowchart 200 depicting an overall process flow of a computer implemented project control system and method. The flow chart 200 directs to step 204 depicting a new project award. The step 204 is directed to step 206 depicting a step of adding enterprise project structure (EPS) using built in menu or entry form. The EPS consists of an organizational breakdown structure, a project structure and multiple job identifications (IDs).

In accordance with an exemplary embodiment of the present invention, the step 206 is directed to a step 208 which includes adding the users and their profiles along with the privileges. The addition of users and their profiles along with the privileges comes under user management. The user management module includes a list of user profiles, a list of privileges and users list and their assigned profile and privileges.

According to non-limiting exemplary embodiment of the present invention, the step 208 further directed to the step 210. The step 210 depicting creating a base data or reference data for multiple project tasks which includes companies and sub-contractors list and their details, plants and equipment's suppliers and their details, materials suppliers and their details, resources or trade classifications and their details, employee list and their details, leave types, daily crew list and their details, supervisor identification list and their details, plant and equipment classifications list, plant and equipment list and their details, purchase order list approval process and their details, materials, fuels and store items list and their details, materials, fuel and store items inventory, measuring units of work output, tangible quantity item list, schedule of rates, cost codes classification, cost code list and their details, work break down structure milestone dates, working shifts and calendars, original budget, resource working hours, plant hours and costs, revised budget resource working hours, plant hours and costs, creating baselines for project tasks on work break down structure milestones, resources and cost forecasts, assigning baselines for project tasks on work break down structure milestones, resources and cost forecasts.

In accordance with an exemplary embodiment of the present invention, the step 210 further directed to a step 212 depicting creating and assigning baselines for the project tasks under the new project as per the approved original budgets and revised budgets. The step 212 directed to a step 214 depicting capture date wise actual data or as build data for resources, work progresses and expenses.

According to a non-limiting exemplary embodiment of the present invention, the step 214 directed to a step 216 depicting actual data or as built data validation and approval process. The step 214 depicting enabling to capture or account daily usage of resources cost codes wise for resource hour utilization, vehicle, plants and equipment's utilization, materials, fuel and consumables used or spent, daily work output (process or product) showing the tangible quantity and materials, fuel and store items transaction and stock records.

In accordance with an exemplary embodiment of the present invention, the step 216 directed to a step 218 depicting generating standard periodical reports in a customized format by using built in tools. The step 218 depicting producing multiple periodical reports for resources, cost, earned value and performance in the form of tables and charts (daily, weekly and monthly or any selected period) at required level of enterprise project structure identification, project task number and cost codes for resources (direct and indirect category), vehicle, plants and equipment's, material, fuel and store consumption quantities, actual costs, work output (tangible quantities item wise), earned value cost, progress claims, any other customized reports, search any data value in the data base, make it easy to organize, sort and filter data in user friendly way.

According to an exemplary embodiment of the present invention, the step 216 further directed to a step 224 depicting archive or back up data for future use upon completion of a project. A step 220 depicting entering data using appropriate menu items and data entry forms directed to the step 210. The step 210 and 212 are directed a step 222 depicting work dairy and staff time sheet entries from multiple users on daily basis (site supervisors and others users) using web based forms or standalone systems. The step 222 further directed to the step 214.

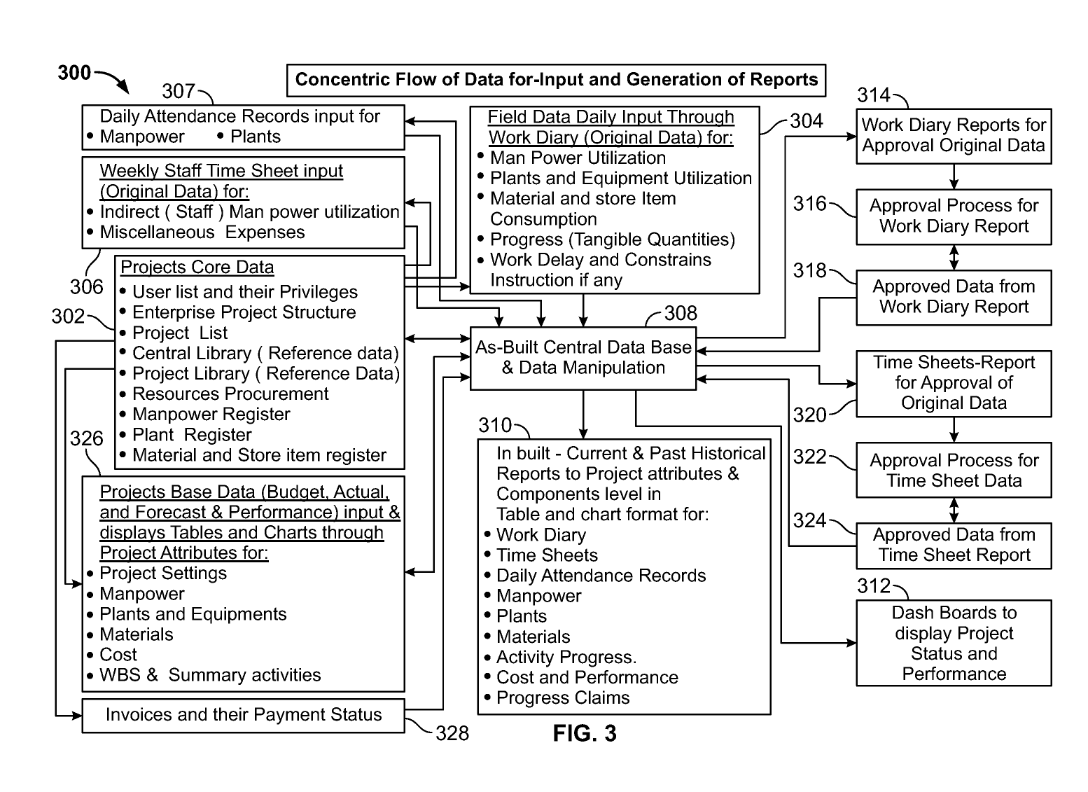

Referring to FIG. 3 is a flowchart 300 depicting a concentric flow of data for a project to and from as built data table. According to an exemplary embodiment of the present invention, the user friendly application developed by the computer implemented project control system with effective monitoring and controlling method which allows better management of a project schedule, resources and cost. The flow chart 300 comprises a step 302 depicting a project core data comprising User list and their Privileges, Enterprise Project Structure, Project List, Central Library (Reference data), Project Library (Reference Data), Resources Procurement, Manpower Register, Plant Register, Material and Store item register.

In accordance with a non-limiting exemplary embodiment of the present invention, the step 302 is directed to a step 304 depicting a field data daily input through the user friendly application developed by the computer implemented system and method for manpower utilization, plant and equipment utilization, material and store item consumption, work progress in a single project of group of projects which will be in tangible quantity, work delay and constraints information if any.

According to an exemplary embodiment of the present invention, the step 302 is directed to a step 306 depicting office staff daily input through staff time sheet for recording indirect resource (engaged in office environment) utilization and miscellaneous expenses. Further the step 302 is directed to step 307 depicting Daily attendance records for manpower and daily working status for plants to facilitate creation of daily attendance records for men and daily working status for plants deployed on projects. Further step 302 is directed to step 328 depicting Invoices and their Payment Status to enable user to create Invoice list and update status on payments.

Further the steps 304, 306, 307 and 328 are directed a step 308 depicting central as-built data base and data manipulation. The step 308 stores data pertains to project or multiple projects and it does data manipulation and analysis. The step 308 is directed to a step 310 depicting In built—Current & Past Historical Reports to Project attributes & Components level in Table and chart format for Work Diary, Time Sheets, Daily Attendance Records, Manpower, Plants, Materials, Activity Progress, Cost, Performance and Progress Claims. The step 308 further directed to a step 312 depicting a Dashboard reports showing Status and performance of a project or group of projects.

In accordance with a non-limiting exemplary embodiment of the present invention, the step 308 depicting data pertains to project or multiple projects and it does data manipulation, analysis and generation of various project reports for the single project of multiple projects. The various project reports includes but not limited to a work diary report for approval original data 314, approval process for work diary report 316, approved data from work diary report 318, time sheets report for approval of original data 320, approval process for time sheet data 322 and approved data from time sheet report 324.

The step 302 depicting a project core data directs to Step 326 depicting Projects Base Data (Budget, Actual, and Forecast & Performance) input & displays Tables and Charts through Project Attributes for Project Settings, Manpower, Plants and Equipment's, Materials, Cost, WBS & Summary activities to enable user to assign budgets and set baselines. The step 308 as built data base directs to step 328 depicting Project Base Data to transmit as built actual data into various project attributes and components through automatic process.

The flow chart 300 enables the project core data creation and selection from data base or application by the users. The flow chart further enables to set various resources and cost budgets and schedules, create WBS and scope of works schedules and set target plans and baselines. The flow chart 300 further enables the data input from site supervisors or users using the work diary developed by the computer implemented management system and method. The staff time sheet generation, daily attendance records and invoices status and periodical report generation and approval processes are provided to the users in a customized report format which further enables the efficient management of the single or multiple project by effectively controlling and monitoring the project by the more effective management system with monitoring and controlling method.

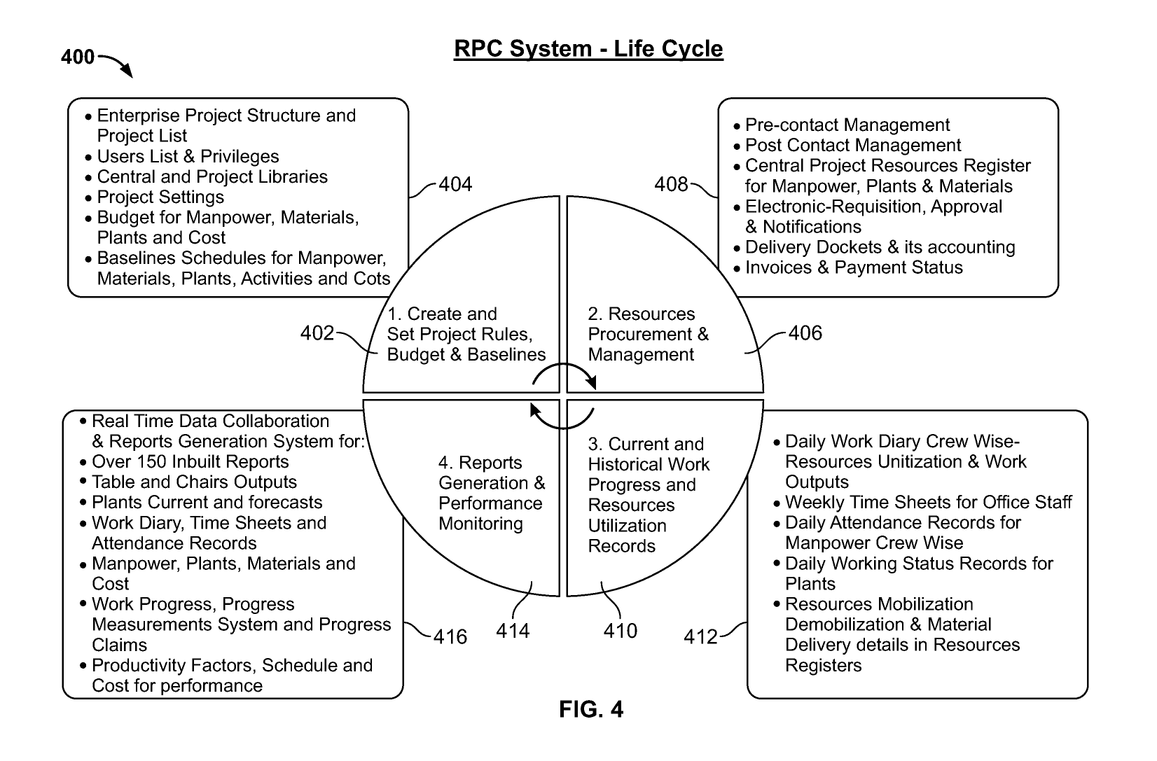

FIG. 4 is a diagram 400 depicting a life cycle of a computer implemented project control system in accordance with an exemplary embodiment of the present invention. The computer implemented project control system provides a user friendly web-based enterprise project structure module with built in tools for providing a project level rules and user level security. The system further provides flexibility to the users to manage multiple projects at required level of attribute depending the size and complexity of project. The system includes creating and setting project rules, budget and baseline 402 which further includes EPS and project list, users list and user privileges, central and project libraries, define project rules and project settings, budget for resources, materials, plants and cost, baseline schedules for resources, materials, plants, activities and cost 404.

The system enables the user to set business rules and impose time limits to carry out certain essential activities by the project team using the project setting tools depending upon the user requirements, scale and complexity of the project. The time limits for initiation and approval process are enforced for procurement, employee transfer, plant transfer, material transfer. and capable to maintain the Relationship between Project estimate and the budget are established by using the tools available under project library which includes but not limited to schedule of estimate (SOE), schedule of rates (SOR), cost codes schedule and scope of work (SOW). The SOE is established based on project estimate prepared during pre-contract stage of the project. The SOR, cost codes schedule and SOW are established in post contract stage and before commencing any project activities.

In accordance with an exemplary embodiment of the present invention, the system includes resources procurement and management 406 which further includes a pre contract management, post contract management, central project resources register for resources, plants and materials, electronic requisition, approval and notifications, delivery dockets and its accounting, invoices and payment status 408. The pre contract management includes pre-contract identification list, reference documents list including resource schedule, drawings and specifications, interface with cost codes and active vendor list, initiation of proposal and approval to proceed with references, bidding correspondence, evaluation and recommendations and award of purchase order or sub contract. The post contract management includes purchase order list, procurement categories which includes resources, material, plants and services, resources identifications, purchase order schedule item identification wise which includes quantity, cost, amount and delivery dates, auto fill in details of actual delivery of all resources with reference to delivery dockets and through resources registers and invoices list and its payment status.

According to a non-limiting exemplary embodiment of the present invention, the system includes current and historical work progress, actual cost and resources utilisation records 410 which further includes daily work diary crew wise-resources utilisation and work outputs, weekly time sheets for office resources, daily attendance records for resources crew wise, daily working status records for plants, resources mobilisation, demobilisation updates in resources registers, material delivery details in material registers 412.

In accordance with a non-limiting exemplary embodiment of the present invention, the system includes reports generation and performance monitoring 414 which further includes real time data collaboration and reports generation system for over 120 inbuilt reports, table and chart outputs, past, current and forecasts, work diary, time sheet and attendance records, resources, plants, materials and cost, work progress, progress measurement system and progress claims, productivity factors, schedule and cost performance 416.

According to a non-limiting exemplary embodiment of the present invention, the system monitors the permanence of the multiple projects and its resources down to cost code level based on Schedule performance index (SPI), Cost performance index (CPI), To complete performance index (TCI), Productivity factor for manpower (PF), Earned values hours for manpower (EV) and Earned value cost (EV).

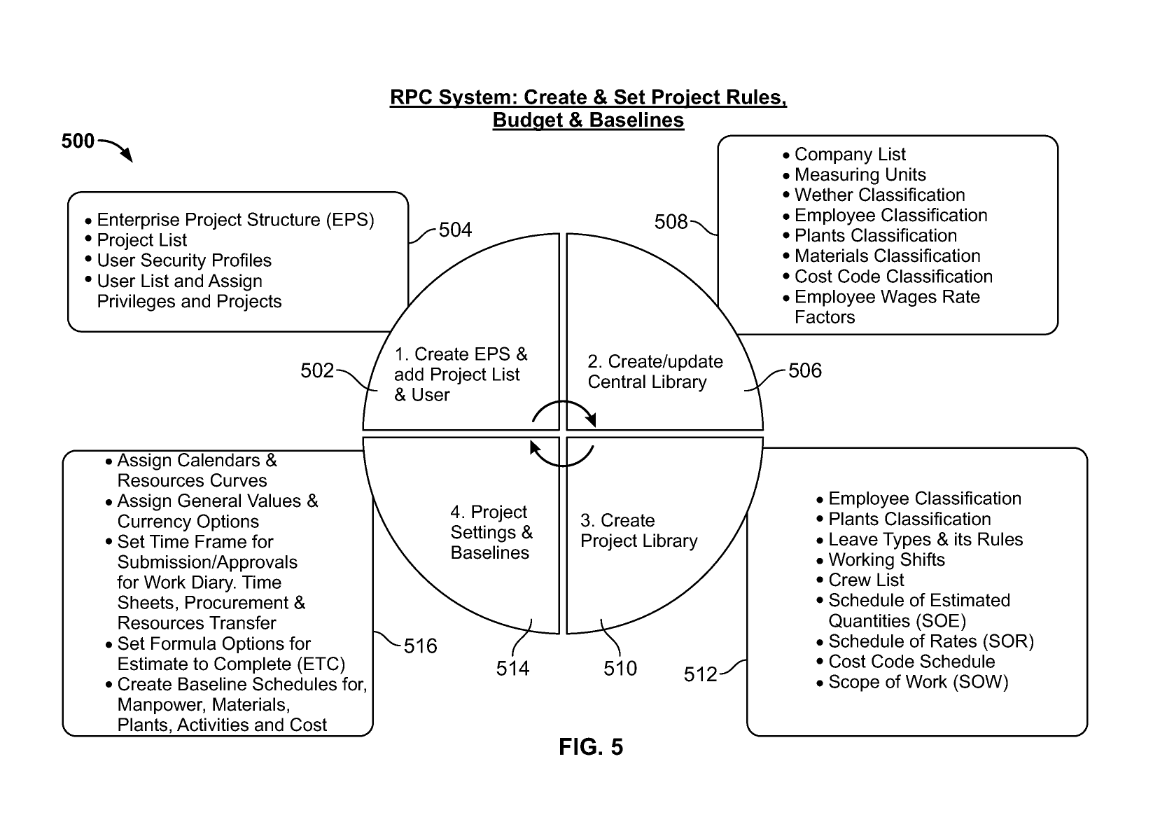

FIG. 5 is a diagram 500 depicting a life cycle of a computer implemented project control system module for setting project rules, budgets and baselines in accordance with an exemplary embodiment of the present invention. The computer implemented project control system provides a user friendly web-based enterprise project structure module with built in tools for providing a set of project rules, budget and baselines. The system further provides monitoring performance of a computer implemented project control system by generating a plurality of standard periodical reports. The system includes creating enterprise project structure (EPS) and adds project list and users 502, project list, user security profiles, user list and assign privileges and projects 504. The system also includes creating or updating a central library 506 which further includes company list, measuring units, whether classification, employee classification, plants classification, materials classification, cost code classification and employee wages rate factors 508.

In accordance with an exemplary embodiment of the present invention, the system includes creating a project library 510 which further includes employee classification, plant classification, leave types and its rules, working shifts, crew list, schedule of estimated quantities (SOE), schedule of rates (SOR), cost code schedule and scope of work (SOW) 512. The system enabling a user to create personalized project rules for enabling an execution of the project. The system further includes project settings and baselines 514 which further includes assign calendars and resource curves, assign general values and currency options, set time frame for submission or approvals for work diary, time, sheets, procurement and resources transfer, set formula options for estimate to complete (ETC), create baseline schedules for, manpower, materials, plants, activities and cost 516.

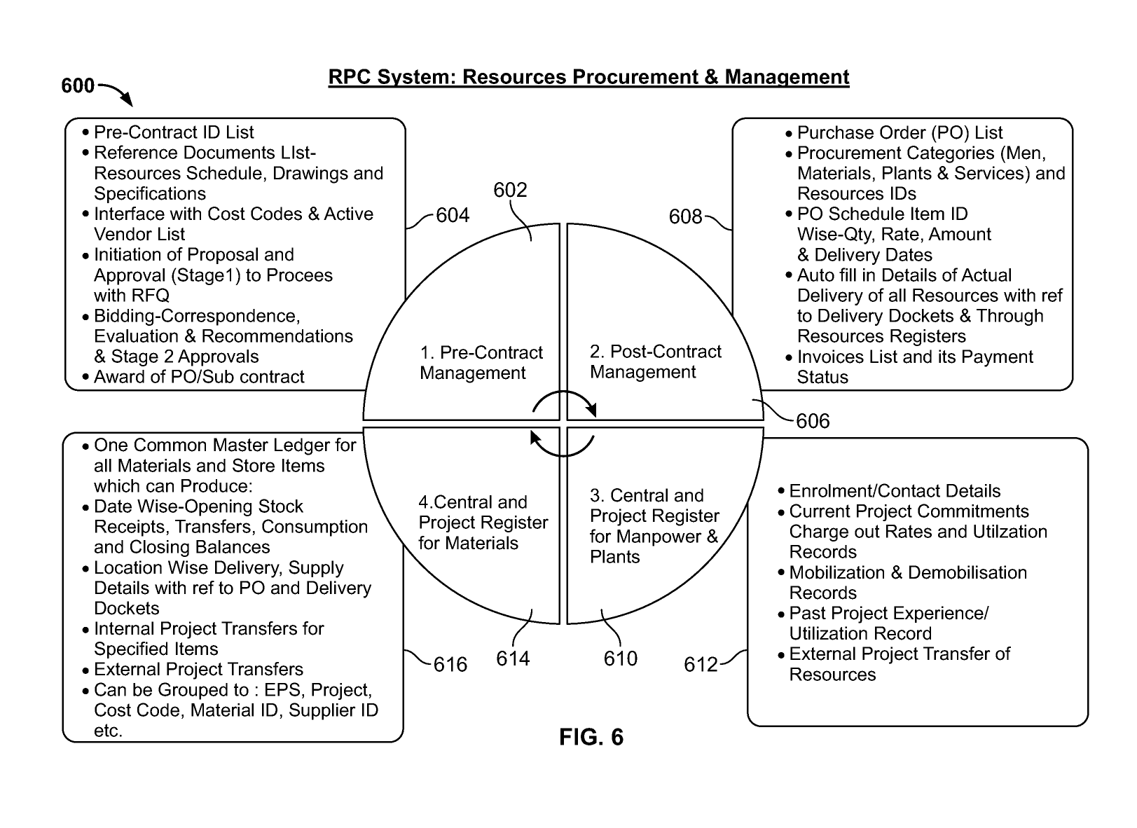

FIG. 6 is a diagram 600 depicting a life cycle of a computer implemented project control system module for resources procurement and their management in accordance with an exemplary embodiment of the present invention. The computer implemented project control system facilitating the user to analyse a project data and the plurality of periodical reports in a user defined format. The system further provides pre-contract management 602 of a computer implemented project control system by pre-contract ID list, reference documents list-resource schedule, drawings and specifications, interface with cost codes and active vendor list, initiation of proposal and approval to proceed with RFQ, bidding-correspondence, evaluation and recommendations and approvals and award of PO/sub contract 604. The system further provides post-contract management 606 of a computer implemented project control system by purchase order (PO) list, procurement categories and resources Ids, PO schedule item ID wise-quantity, rate, amount and delivery dates, auto fill in details of all resources with ref to delivery dockets and through resources registers and invoices list and its payment status 608.

In accordance with an exemplary embodiment of the present invention, the system includes central project register for manpower and plants 610 which includes enrolment or contact details, current project commitments, charge out rates and utilisation records, mobilisation and demobilisation records, past project experience or utilisation record and external project transfer of resources 612. the system further includes central and project register for materials 614 which further includes one common master ledger for all materials and store items which can produce data wise-opening stock, receipts, transfers, consumption and closing balance, location wise delivery, supply details with ref to PO and delivery dockets, internal project transfers for specified items, external project transfers and can be grouped to EPS, project, cost code, material ID, supplier ID etc., 616.

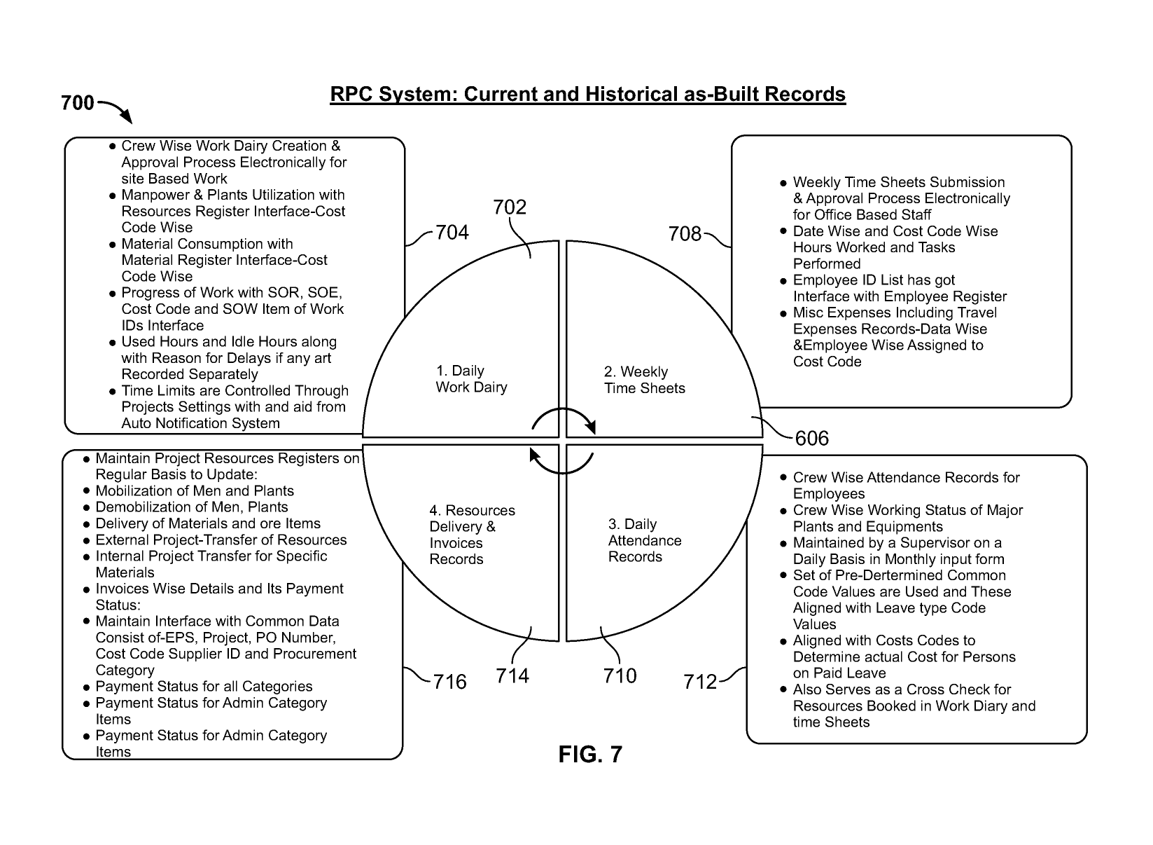

FIG. 7 is a diagram 700 depicting a life cycle of a computer implemented project control system module for creation and management of current and historical as-built records in accordance with an exemplary embodiment of the present invention. The computer implemented project control system providing status information of the project, wherein the status information comprises at least one of a time estimation, a cost estimation, a resource estimation and a work estimation. The system further provides daily work diary 702 of a computer implemented project control system crew wise work diary creation and approval process electronically for site based work, manpower and plants utilisation with resources register interface-cost code wise, material consumption with material register interface-cost code wise, progress of work with SOR, SOE, cost code and SOW, item of work ids interface, used hours and idle hours along with reasons for delays if any are recorded separately and time limits are controlled through projects settings with an aid from auto notification system 704.

In accordance with an exemplary embodiment of the present invention, the system includes weekly time sheets 706 which includes weekly time sheets submission and approval process, electronically for office based staff, date wise and cost code wise hours worked and tasks performed, employee ID list has got interface with employee register and miscellaneous expenses including travel expenses records-date wise and employee wise assigned to cost coded 708. The system includes daily attendance records 710 which includes crew wise attendance records for all employees, crew wise working status of major plants and equipment's, maintained by a supervisor on a daily basis in monthly input form, set of pre-determined common code values are used and these aligned with leave type code values, aligned with cost codes to determine actual cost for persons on paid leave and also serves as a cross check for resources booked in work diary and time sheets 712.

In accordance with an exemplary embodiment of the present invention, the system includes resources delivery and invoices records 714 which includes maintain project resources registers on regular basis to update mobilisation of men and plant, demobilisation of men and plants, delivery of materials and ore items, external project transfer of resource and internal project transfer for specific materials. Invoices wise details and its payment status to maintain interface with common data consist of EPS, project, PO number, cost code supplier ID and procurement category, payment status for all categories, payment status for admin category items and payment status for services category items 716. An effective method of managing a project execution method comprising a step of adding at least one of a user; a user profile; and a user privilege by utilizing at least one user management module.

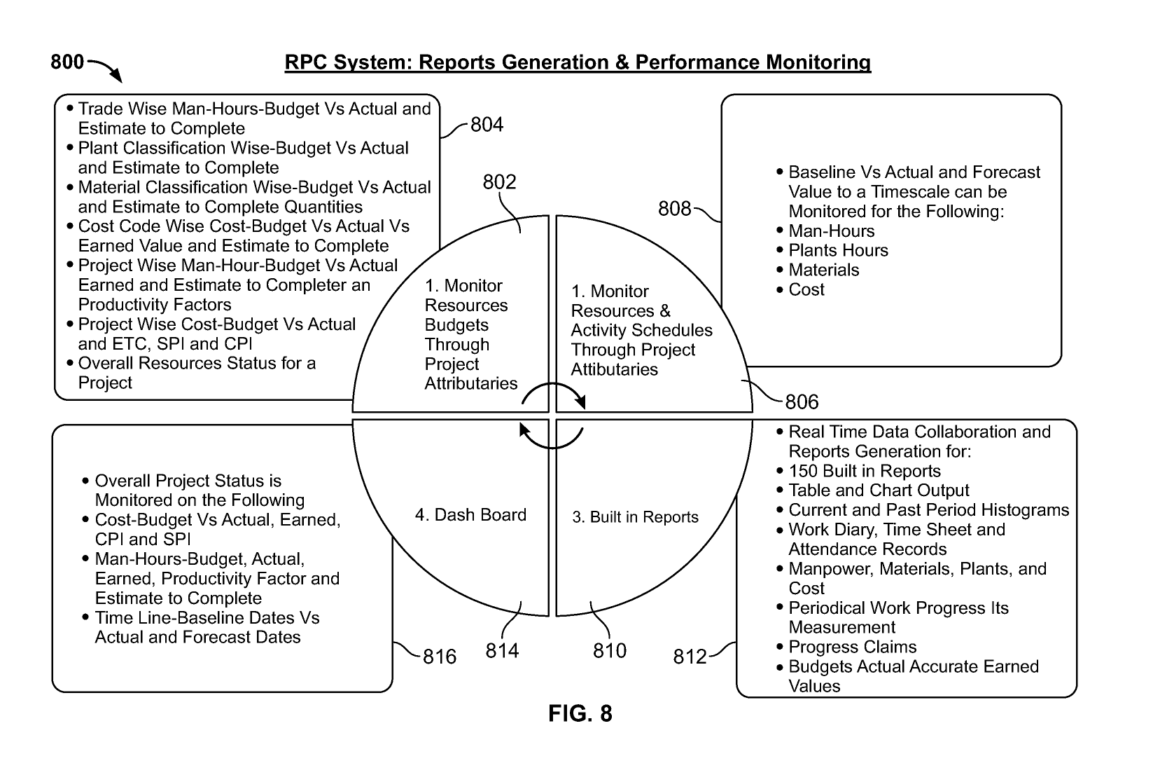

FIG. 8 is a diagram 800 depicting a life cycle of a computer implemented project control system module for reports generation and performance monitoring in accordance with an exemplary embodiment of the present invention. A step of retrieving a plurality of project tasks from at least one secured central database, wherein the project task determines an activity to be performed by available resources. The system further includes monitoring resources budgets through project at tributaries 802 of a computer implemented project control system includes trade wise man hours budget against actual and estimate to complete, plant classification wise budget against actual and estimate to complete, material classification wise budget against actual and estimate to complete quantities, cost code wise cost-budget against actual against earned value and estimate to complete, project wise man hour budget against actual earned and estimate to complete and productivity factors, project wise cost budget against actual, earned and ETC, SPI and CPI and overall resources status for a project 804.

In accordance with an exemplary embodiment of the present invention, a step of displaying the plurality of project tasks to a user for enabling an efficient organization of available resources and a step of scheduling the plurality of resources for enabling a completion of the plurality of project tasks at a predetermined time. The system includes monitor resources and activity schedules through project at tributaries 806 which includes base line against actual and forecast values to a timescale can be monitored for the man-hours, plant hours, materials and cost 808. The system further includes build in reports 810 which generate real time data collaboration and report which are 150 built in reports, table and chart output, current and past period histograms, work diary, time sheet and attendance records, manpower, materials, plants and cost, periodical work progress its measurement, progress claims, budgets, actual, accruals, earned values, productivity factor, SPI and CPI values 812.

In accordance with an exemplary embodiment of the present invention, a step of tracking a completion status of the plurality of projects and a step of updating a status of the plurality of tasks of the plurality of projects in the at least one secured central database. The system includes dash board 814 which monitors overall project status by cost budget against actual, earned, CPI and SPI, man hour's budget, actual, earned productivity factor and estimate to complete and timeline-baseline dates against actual and forecast dates 816.

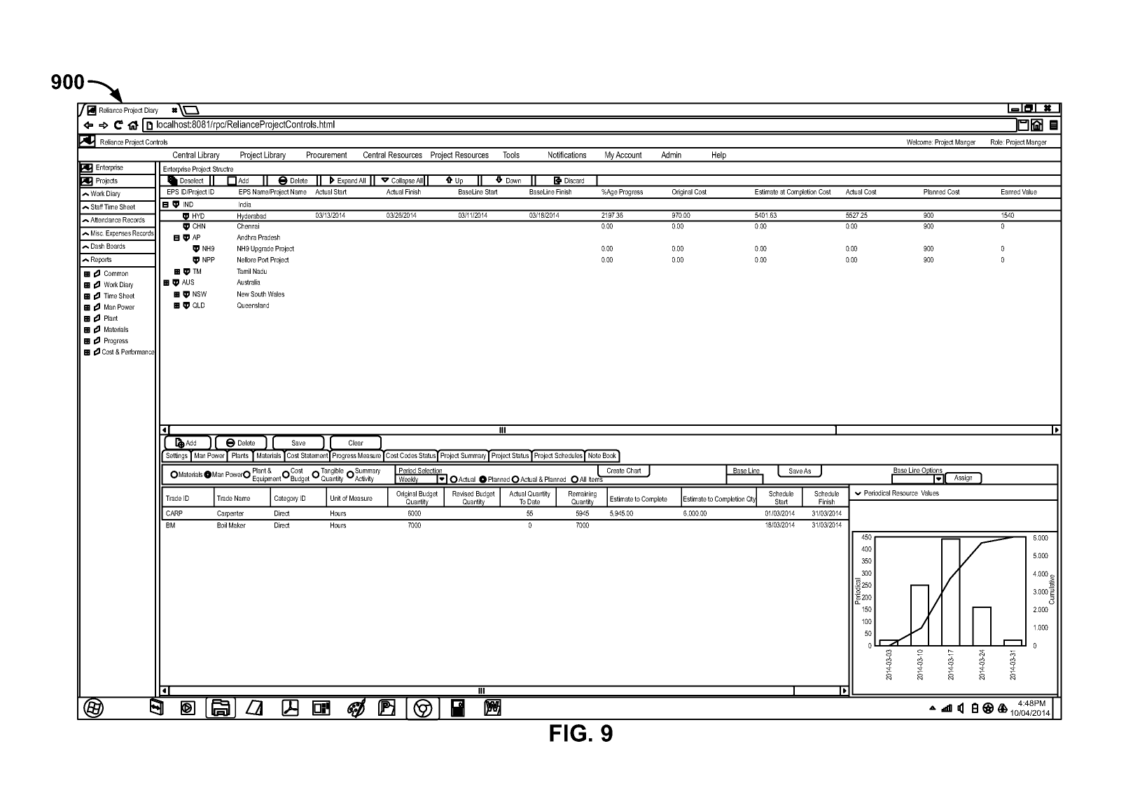

FIG. 9 is a diagram 900 depicting, a RPC system module for EPS and project list along with project attributes in accordance with an exemplary embodiment of the present invention.

While specific embodiments of the invention have been shown and described in detail to illustrate the inventive principles, it will be understood that the invention may be embodied otherwise without departing from such principles.

What is claimed is:

1. A computer implemented project control system adapted for enabling an effective management of a project, the system comprising:
an enterprise project structure module configured to generate a computerized simulation model representing a plurality of project details;
at least one secured central database for storing the details of the plurality of projects by enabling a multiuser environment;
at least one user management module for adding at least one of a user; a user profile; and a user privilege;
a plurality of libraries, comprising:
at least one central library; and
at least one project library for maintaining a reference data;
a plurality of built in tools to produce a plurality of standard periodical reports;
at least one central processing module for performing a plurality of project related operations; and
at least one remotely located central server for facilitating a communication between the enterprise project structure module and the at least one secured central database for enabling an operation.

2. The computer implemented project control system of claim 1, a plurality of projects further comprising:
a plurality of product related components; and
a plurality of process related components.

3. The computer implemented project control system of claim 1 further comprising a computer program product adapted for developing a component based application capable of organizing the plurality of projects.

4. The computer implemented project control system of claim 1, wherein the plurality of built in tools produces the plurality of standard periodical reports with a facility to create a layout utilizing and sorting of a plurality of data field items.

5. The computer implemented project control system of claim 1, wherein the enterprise project structure module further comprising at least one of:
an organizational breakdown structure;
a project structure; and
a project task identification.

6. A computer implemented project control method adapted for enabling an effective management of a project by utilizing the computer implemented project control system, the method comprising:
a step of creating a plurality of libraries for maintaining a reference data,
wherein the plurality of libraries comprises:
at least one central library; and
at least one project library;
a step of locating a plurality of:
project rules;
budgets; and
baseline schedules;
a step of obtaining a plurality of resources;
a step of managing the plurality of resources by a plurality of asset registers;
a step of enabling an automatic transfer of the plurality of resources between the plurality of projects at a predetermined time interval;
a step of maintaining at least one of:
a historical record;
a work progress;
an actual cost; and
a resource utilization; and
a step of real time project data collaboration, data manipulation and performance monitoring of a computer implemented project control system through inbuilt dash boards, project attribute data tables and charts and by generating a plurality of standard periodical reports.

7. The method of claim 6 comprising a step of enabling a user to create personalized project rules for enabling an execution of the project.

8. The method of claim 6 comprising a step of facilitating the user to analyze a project data and the plurality of periodical reports in a user defined format.

9. The method of claim 6, further comprising a step of providing a status information of the project, wherein the status information comprises at least one of:
a time estimation;
a cost estimation;
a resource estimation; and
a work estimation.

10. An effective method of managing a project execution, the method comprising:
a step of adding at least one of a user; a user profile; and a user privilege by utilizing at least one user management module;
a step of retrieving a plurality of project tasks from at least one secured central database, wherein the project task determines an activity to be performed by available resources;
a step of displaying the plurality of project tasks to a user for enabling an efficient organization of available resources;
a step of scheduling the plurality of resources for enabling a completion of the plurality of project tasks at a predetermined time;
a step of tracking a completion status of the plurality of projects; and
a step of updating a status of the plurality of tasks of the plurality of projects in the at least one secured central database.
